(19) United States
(12) Patent Application Publication
(10) Pub. No.: US 2012/0251226 A1
(43) Pub. Date: Oct. 4, 2012

(54) DEFORMABLE CONNECTION MECHANISM FOR CONNECTING TWO SHELLS

(75) Inventors: XIN-ZHANG LIU, Shenzhen City (CN); SHOU-JI LIU, Shenzhen City (CN); TE-SHENG JAN, Tu-Cheng (TW); YU-TAO CHEN, Tu-Cheng (TW); CHUN-CHE YEN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/216,179

(22) Filed: Aug. 23, 2011

(30) Foreign Application Priority Data
Mar. 28, 2011 (CN) 201110074614.0

(51) Int. Cl. F16B 17/00

(52) U.S. Cl. 403/280

(57) ABSTRACT

A deformable connection mechanism includes an insert member, a socket member, a first shell and a second shell defining a through hole. The insert member extends form the first shell. The socket member is formed on the second shell. The insert member includes shaft body and an elastic head. The socket member includes a receiving hole communicating with the through hole and an elastic sidewall surrounding the receiving hole. The elastic head and the sidewall are deformable. The insert member is passable through the receiving hole. The elastic head has a size larger than that of the receiving hole.

### BACKGROUND

1. Technical Field

The present disclosure relates to a deformable connection mechanism for connecting two shells.

2. Description of Related Art

Screws are usually used to connect two shells of an electronic device. During assembling or disassembling of the two shells, a screwdriver is employed to turn the screws. When a screwdriver is not at hand, it is difficult to turn the screws. It is useful and desirable to provide a deformable connection mechanism that can be assembled/disassembled without the use of tools.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a deformable connection mechanism.

FIG. 2 is an exploded view of FIG. 1, showing the first shell detached from the second shell.

FIG. 3 is an enlarged view of III of the fastener in FIG. 1.

FIG. 4 is a cross-sectional view taken along the line IV-IV of FIG. 3.

FIG. 5 is similar to FIG. 3, but illustrating the elastic head received in the receiving hole.

### DETAILED DESCRIPTION

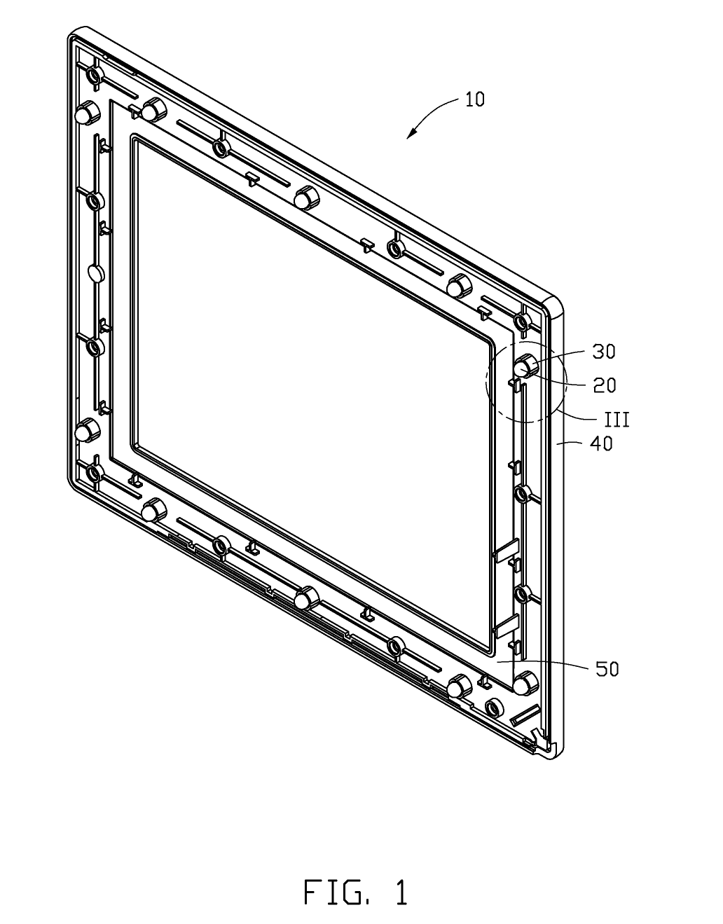

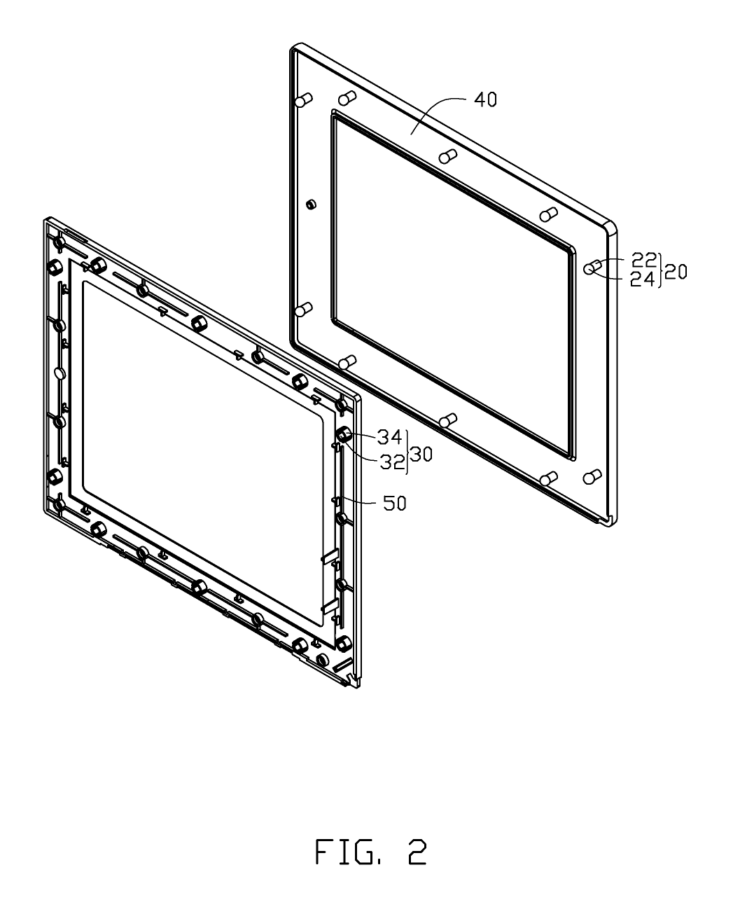

Referring to FIGS. 1 to 4, a deformable connection mechanism 10 according to an exemplary embodiment includes a number of insert members 20, a number of socket member 30, a first shell 40 and a second shell 50. The number of the insert members 20 extends from an inner side of a first shell 40. The number of the socket members 30 are formed on an inner side of a second shell 50 opposite to the insert member 20.

Each insert member 20 includes a shaft body 22 perpendicular to the first shell 40, and an elastic head 24 formed on an end of the shaft body 22. The second shell 50 defines a number of through holes 52 corresponding to the elastic heads 24. Each socket member 30 defines a receiving hole 32 communicating with one through hole 52. An elastic sidewall 34 surrounds each receiving hole 32. The elastic sidewall 34 is to prevent the elastic head 24 from disengaging from the receiving hole 32, thereby fixing the first shell 40 to the second shell 50.

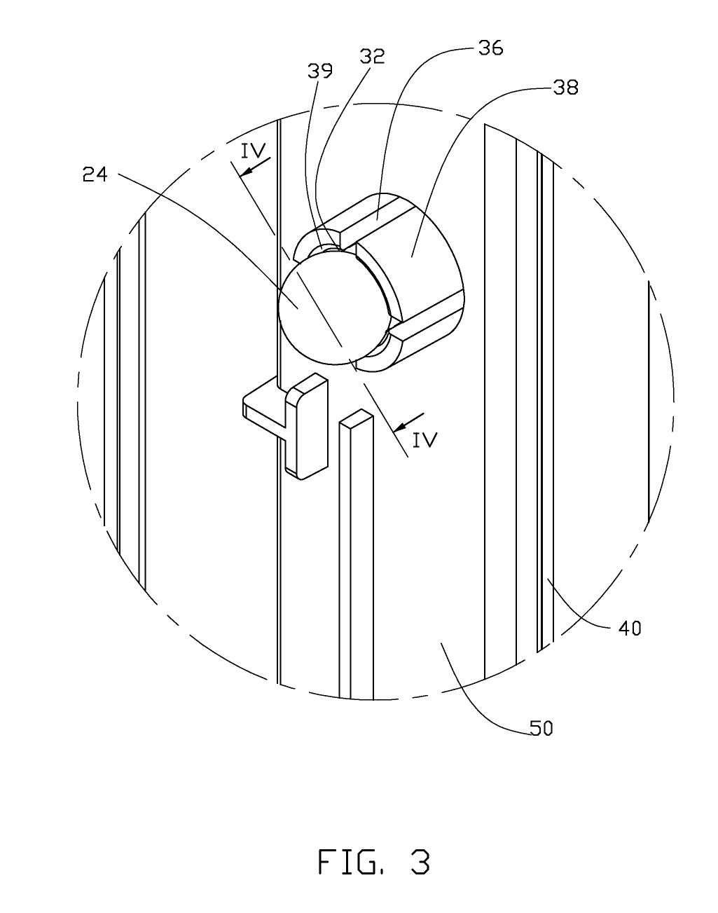

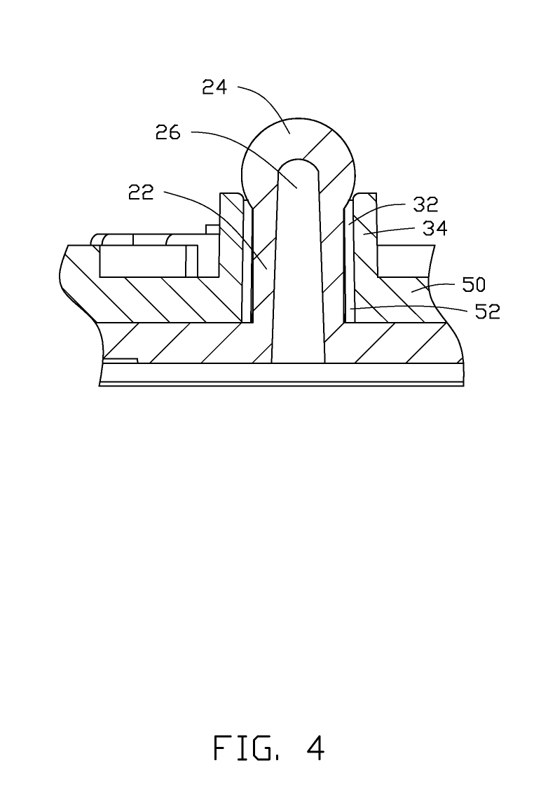

Referring again to FIGS. 3 and 4, the elastic head 24 is substantially spherical. The elastic head 24 has a size larger than that of the receiving hole 32. The insert member 20 defines a blind hole 26 extending from the shaft body 22 facing away form the elastic head 24. When the insert member 20 is inserted into the receiving hole 32 of the socket member 30, the blind hole 26 allows the insert member 20 to be deformed. In the embodiment, the insert member 20 and the first shell 40 can be integrally formed by molding.

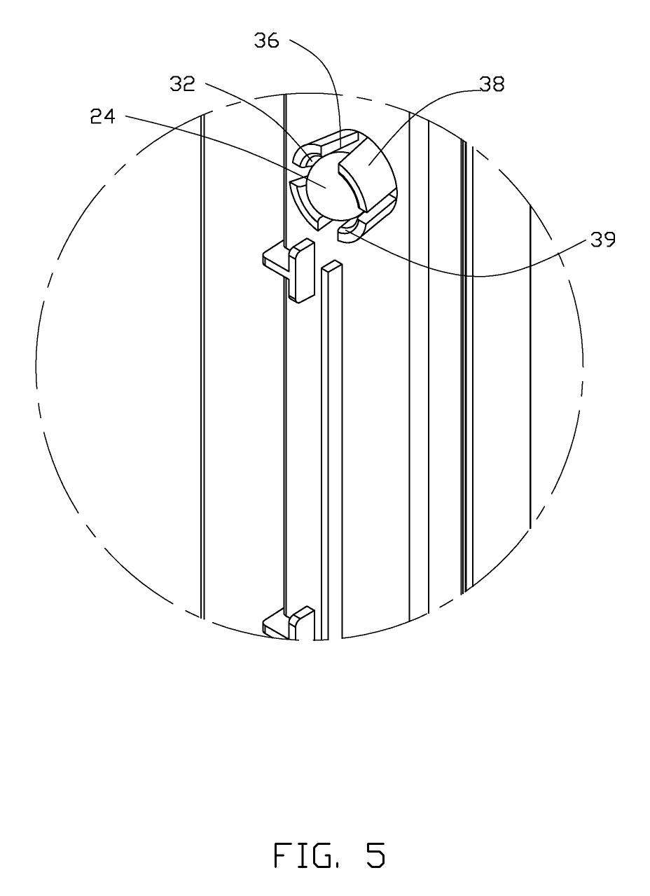

The elastic sidewall 34 defines a number of slots 36. The slots 36 divide the elastic sidewall 34 into a number of independent elastic pieces 28. When the elastic sidewall 34 is urged by the elastic head 24 of the insert member 20, the slots 36 allow the elastic sidewall 34 to expand outward. Referring to FIGS. 4 and 5, when the elastic head 24 is inserted into the receiving hole 32, the elastic pieces 38 are urged to expand outward, thereby enlarging the receiving hole 32 and allowing the elastic head 24 to pass through the receiving hole 32. Referring back to FIG. 3, after the elastic head 24 pass through the receiving hole 32, the elastic pieces 38 and the elastic head 24 rebound and recover to their original shapes. The elastic head 24 cannot move due to the limitation of the elastic sidewall 34, thereby fixing the first shell 40 to the second shell 50. In the embodiment, the elastic sidewall 34 is beveled at a distal end thereof for easy withdrawing of the elastic head 24 from the receiving hole 32.

It is to be understood, however, that even though numerous characteristics and advantages of the present disclosure have been set forth in the foregoing description, together with details of the structure and function of the present disclosure, the present disclosure is illustrative only, and changes may be made in details, especially in matters of shape, size, and arrangement of parts within the principles of the present disclosure to the full extent indicated by the broad general meaning of the terms in which the appended claims are expressed.

What is claimed is:

1. A deformable connection mechanism, comprising:
a first shell;
an insert member extending from the first shell, the insert member comprising a shaft body and an elastic head;
a second shell defining a through hole;
a socket member formed on the second shell, the socket member comprising a receiving hole and an elastic sidewall surrounding the receiving hole, the receiving hole communicating with the through hole, the elastic head and the sidewall being deformable, the insert member being passable through the receiving hole, the elastic head having a size larger than that of the receiving hole.

2. The deformable connection mechanism of claim 1, wherein the elastic head is formed on an end of the shaft body.

3. The deformable connection mechanism of claim 2, wherein the insert member defines a blind hole extending from the shaft body to the elastic head, the blind hole facing away form the elastic head.

4. The deformable connection mechanism of claim 1, wherein the elastic head is substantially spherical.

5. The deformable connection mechanism of claim 1, wherein the elastic sidewall is multi-furcated into a plurality of elastic pieces.

6. The deformable connection mechanism of claim 1, wherein the elastic sidewall is beveled at a distal end thereof.
